(19) United States
(12) Patent Application Publication
(10) Pub. No.: US 2020/0201457 A1
(43) Pub. Date: Jun. 25, 2020

(54) INTELLIGENT CONTROL SYSTEM AND MOBILE DEVICE ASSOCIATED THEREWITH

(71) Applicants: FU DING PRECISION COMPONENT (SHEN ZHEN) CO., LTD., Shenzhen (CN); FOXCONN INTERCONNECT TECHNOLOGY LIMITED, Grand Cayman (KY)

(72) Inventor: CHUNG-NAN KO, New Taipei (TW)

(21) Appl. No.: 16/721,845

(22) Filed: Dec. 19, 2019

(30) Foreign Application Priority Data
Dec. 19, 2018 (CN) 201811557845.5

(51) Int. Cl. G06F 3/041; G06F 3/0484; B60K 37/04; B60R 11/02

(52) U.S. Cl. CPC G06F 3/041; G06F 3/04847; B60K 37/04; B60R 11/0235; B60R 2011/0012; B60K 2370/46; B60K 2370/77; B60K 2370/1438; B60K 2370/152

(57) ABSTRACT

An intelligent control system for use within a car includes a plurality of connection stations at different positions, and at least one smart display. The display includes a mating seat adapted to be detachably connected to the connection station. The display may show the main use interface (UI) corresponding to such a specific connection station recognized by the intelligent control system. The connection station includes detection circuits to inform the system of the connected display and allow the correct corresponding UI to be shown on the display. The display may be a tablet so as to connect with the computer system of the car for obtaining the data of the car.

### BACKGROUND OF THE DISCLOSURE

### 1. Field of the Disclosure

The present disclosure relates to an intelligent control system for use within a car, and particularly the same mobile device adapted to be used with different places in the system while showing the different function icons and displaying the different contents according to the desired functions based upon the position difference.

### 2. Description of Related Arts

Taiwan Patent No. TW1608249 discloses an image displayed and projected behind the windshield glass along the driver's sight in the car. Anyhow, such a device is required to be embedded within the panel deck behind the steering wheel. Also, a touch panel is requisitely embedded within a vertical face of the panel deck for the driver use. In addition, a plurality of panels are equipped within the different positions in the card, including the back side of the front seat back for allowing the back seat passengers to view the movies, etc.. Most of time, there is less chance to use all the equipped displays at the same time. In other words, the display or touch panel device may be optionally or selectively used in some positions in the car in a circumstance. Therefore, to have all positions in the car equipped with the touch panels or display devices may be not an economic way.

An improved arrangement is desired to provide an intelligent control system with a plurality of connection stations ready for coupling with the discrete display or touch panel devices, respectively, wherein the less number amount of the display or touch panel devices can be optionally and selectively coupled respectively with the desired connection stations for the intended use in such a situation. Understandably, the different connection stations can be selected in another circumstance flexibly.

### SUMMARY OF THE DISCLOSURE

An object of the invention is to provide an intelligent control system for use within a car with a plurality of connection stations at different positions, and at least one smart display. The display includes a mating seat adapted to be detachably connected to the connection station. The display may show the main use interface (UI) corresponding to such a specific connection station recognized by the intelligent control system. The connection station includes a detection circuit to inform the system of the connected display and allow the correct corresponding UI to be shown on the display. The display may be a tablet so as to connect with the computer system of the car for obtaining the data of the car. The connection station can be a Keyssa connector. The connection station can be a pogo connector. The connection station further includes a magnet mechanism for retention between the display and the connection station. The mating seat of the smart display may be connected to the connection station of the control system wirelessly.

Other objects, advantages and novel features of the disclosure will become more apparent from the following detailed description when taken in conjunction with the accompanying drawings.

### BRIEF DESCRIPTION OF THE DRAWINGS

FIG. 1 is a diagram showing the intelligent control system for use within a car according to the invention.

### DETAILED DESCRIPTION OF THE PREFERRED EMBODIMENT

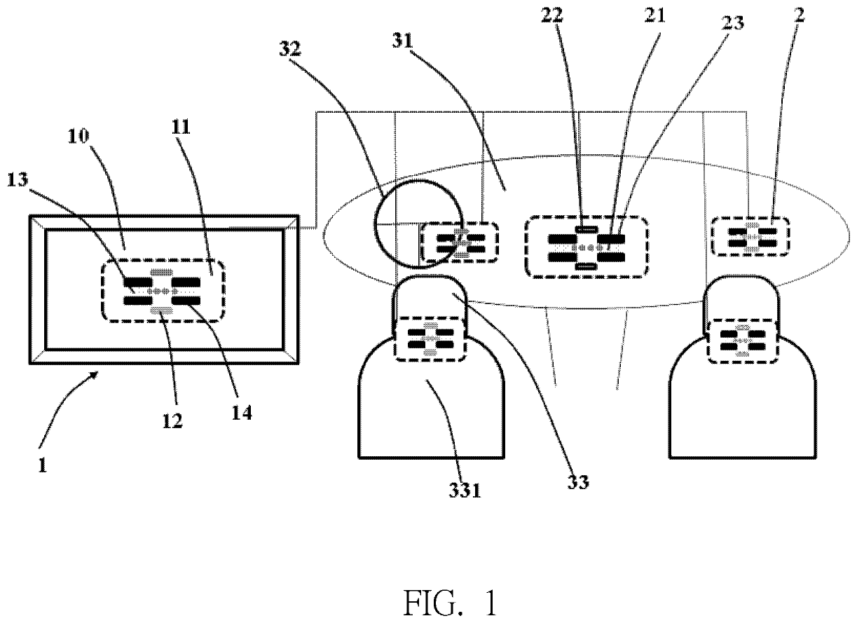

Referring to FIG. 1 an intelligent control system (not labeled) for use within a car, includes at least one smart display 1 and a plurality of connection stations 2 located at different positions of the car. The smart display can be connected to any of the connection stations and display the corresponding UI specifically.

The car includes a central control region 31, a steering wheel 32, a front seat 33 and a back seat (not labeled). The front seat 33 includes a front side and a rear side 331 of the seat back. The connection station 2 can be located between the steering wheel 32 and the windshield (not labeled), under the steering wheel 32, one the central control region 31, and the rear side 331 of the front seat back as long as the smart display 1 can be detachably attached to the connection station.

The connection stations 2 are same with one another and each is equipped with the detection circuit (not labeled). The smart display 1 includes a mating seat 11 adapted to be coupled to the connection station 2. Via the detection circuit on each connection station 2, the control system may provide the corresponding UI on the smart display 1. For example, the display attached upon the connection station on the rear side of the front seat back may provide functions for movie watching or seat adjustment or air conditioning adjustment.

The connection station 2 may include the Keyssa connector or pogo pin connector. The connection station 2 may include the connection points 21, the positioning seat 22 and the magnets 23. The display 1 may be the tablet to connect to the computer system of the car for obtaining the data of the car. The mating seat 11 is located on the back face of the display 1 and includes the positioning pin 12, the connection points 13 and the magnets 14 for coupling to the positioning seat 22, the connection points 21 and the magnets 23, respectively. The connection between the connection station 2 and the mating seat 11 may be either via the connectors or wirelessly. Such a mobile type display may lower the cost of the car, of which the plural displays are originally required to be built within the car.

While a preferred embodiment in accordance with the present disclosure has been shown and described, equivalent modifications and changes known to persons skilled in the art according to the spirit of the present disclosure are considered within the scope of the present disclosure as described in the appended claims.

What is claimed is:

1. An intelligent control system for use within a car, comprising:
a plurality of connection stations located at different positions inside the car, each of said connection station being equipped with detection circuits; and
at least one mobile smart touch display detachably attached to the selected connection station; wherein
each of the connection stations is equipped with detection circuit to have the control system know whether the touch display is connected thereto so that the control system provides a corresponding user interface on the touch display for user operation.

2. The intelligent control system as claimed in claim 1, wherein a back side of the touch display is equipped with a mating seat for coupling with the connection station.

3. The intelligent control system as claimed in claim 2 wherein both the connection station and the mating seat include connectors for mating with each other electrically.

4. The intelligent control system as claimed in claim 2 wherein both the connection station and the mating seat include the positioning devices for alignment consideration during coupling.

5. The intelligent control system as claimed in claim 2, wherein both the connection station and the mating seat include magnets for retention therebetween.

6. The intelligent control system as claimed in claim 1, wherein the connection station is located at a central control region, between a steering wheel and a windshield, or a rear side of a front seat back.

7. A method of controlling non-driving operations in a car, comprising steps of:
providing an intelligent control system with a plurality of connection stations at different positions in the car;
providing each connection station with detection circuits;
providing a smart touch display with mating seat adapted to be detachably attached to the selected connection station; and
providing a correct user interface on the touch display according to the corresponding connection station of which the detection circuits are activated.

8. The method as claimed in claim 7, wherein the retention between the connection station and the mating seat is performed by magnetic attraction.

9. The method as claimed in claim 7, wherein the electrical connection between the connection station and the mating seat is performed by connectors.

10. The method as claimed in claim 7, w herein the electrical connection between the connection station and the mating seat is performed wirelessly.
